(19) United States
(12) Patent Application Publication
(10) Pub. No.: US 2019/0238954 A1
(43) Pub. Date: Aug. 1, 2019

(54) SYSTEMS AND METHODS FOR DELIVERY OF AUDIO AND VIDEO CONTENT

(71) Applicant: SOUTHERN STAR CORPORATION PTY LTD, Penrith, New South Wales (AU)

(72) Inventor: John William Dawson, Colyton, New South Wales (AU)

(21) Appl. No.: 16/312,108

(22) PCT Filed: Mar. 17, 2017
(86) PCT No.: PCT/AU2017/050239

§ 371 Date: Dec. 20, 2018

Related U.S. Application Data
(60) Provisional application No. 62/353,113, filed on Jun. 22, 2016.

(51) Int. Cl. H04N 21/858; H04N 21/81; H04N 21/658; H04N 21/8358; H04N 21/4223; H04N 21/414; H04N 21/2743; H04W 4/18

(52) U.S. Cl. CPC H04N 21/8586; H04N 21/8146; H04N 21/6581; H04W 4/185; H04N 21/4223; H04N 21/41407; H04N 21/2743; H04N 21/8358

(57) ABSTRACT

A system for transmitting electronic video and/or audio to a device. The system includes: an image a media file association, electronic storage having a media file associated with the image, and a device configured to receive the image or to capture the image. The device is connected with the electronic storage, wherein upon download or capture of the image by the device, the system utilizes the media file association to identify the media file associated with the image and transmits the media file to the device. The media file association may include a marking, graphic, letter or numeral visible or invisible to a human. The marking, graphic, letter or numeral is disposed on or about the image. The system may be used in social media or advertising applications.

### FIELD OF THE INVENTION

The present invention relates to systems and methods for delivering pre-recorded audio or video. In particular, but not exclusively, the invention relates to the delivery of audio or video recorded by a first party to a second party to impart a personal message, a greeting or business information.

### BACKGROUND TO THE INVENTION

Means for the electronic transmission of media files are well known in the art. One common method is for a first party to send an email to a recipient second party, the email having an audio or video file associated as an attachment. Upon receipt of the email, the second party opens the email, reads the content in the email body (if any) and then opens the attachment to play the file on his/her computer or phone.

Another prior art method requires a first party to paste a link to a file sharing service such as Dropbox™ in the body of an email, the link allowing access to only a certain audio or video file stored by the file sharing service. The recipient second party opens the email, and clicks the link to download the file to his/her device. The recipient then locates the stored file (typically via a file manager application) and launches it with a preferred player to access the audio or video content.

Yet a further existing method involves a first party actuating a “share” button on a social media platform as facebook™ and uploading a video to the platform. A second party (typically a friend) visiting the first party's page on the social media platform is able to access the audio or video content.

A problem with the prior art is the need for the intended recipient of a media file to be prompted to access the file, and indeed often requiring the recipient to perform some work (such as clicking, downloading, locating and opening) to access the file.

A further problem is that the invitation to access the media file is not presented in any context, or is presented in a context that is not sufficient to garner interest from the recipient. For example, a video file sent as an email attachment may not catch the interest of a recipient even where the email body includes some text to invite the recipient to attach the recipient.

Yet a further problem presents in the advertising industry whereby an advertising image (such as found in a magazine, newspaper or a moving image on television) contains less than complete information on the advertised product or service. Often, the limitation is due to the nature of the medium (for example, print media are unable to show moving images or sounds), or size of the advertising image (which restricts the amount of text), or the duration of an advertisement (such as a standard 30 second television advertisement). In the prior art, an advertising image may include a URL directing a potential customer to a website for further information. The potential customer must remember the URL, and then enter it into the address bar of a browser application to view or hear the further information. Because URL's can be long and difficult to remember, some advertisers provide short search term that allow a search engine such as Google™ to locate the desired content. In any event, prior art means for imparting further information on a product or service require considerable effort on the part of the potential customer. In many instances, this need for effort can dissuade a potential customer from reviewing more complete information on the advertised product or service.

It is an aspect of the present invention to overcome or ameliorate a problem of the prior art and provide improved systems and methods for the delivery of media files. It is a further aspect to provide an alternative to prior art methods and systems.

### SUMMARY OF THE INVENTION

In a first aspect, but necessarily the broadest as, the present invention provides a system for transmitting electronic video and/or audio to a device, the system comprising: an image comprising media file association means, electronic storage means comprising a media file, a device configured to receive the image or to capture the image, the device being in operable connection with the electronic storage means, wherein upon download or capture of image by the device, the electronic audio or video is transmitted to the device.

In one embodiment of the first aspect, the image is embodied in the form of a physical image.

In one embodiment of the first aspect, the physical image is selected from the group consisting of a hard copy photograph or graphic, or a still or moving image presented on a television screen, a computer screen or a cinema screen.

In one embodiment of the first aspect, the device is configured to capture the physical image by digital capture means.

In one embodiment of the first aspect, the image is embodied in the form of an electronic image file.

In one embodiment of the first aspect, the image file comprises or is associated with a computer readable identifier.

In one embodiment of the first aspect, the device is configured to receive the image by download across a network.

In one embodiment of the first aspect, the image is of photographic quality.

In one embodiment of the first aspect, the image comprises human comprehensible indicium identifying the photograph as being associated with a media file.

In one embodiment of the first aspect, the media file association means comprises the actual file location, or a proxy for the actual file location.

In one embodiment of the first aspect, the media file association means comprises a marking, graphic, letter or numeral visible or invisible to a human, the marking, graphic, letter or numeral being disposed on or about the image.

In one embodiment of the first aspect, the media file association means is a watermark disposed on or about the image.

In one embodiment of the first aspect, the watermark is substantially imperceptible to the unaided human eye.

In one embodiment of the first aspect, the media file association means is a series of markings deliberately disposed on the image for the purpose of encoding media file association information.

In one embodiment of the first aspect, the markings are printed in an ink capable of emitting or reflecting electromagnetic radiation of a wavelength outside the visible spectrum.

In one embodiment of the first aspect, the markings are repeated across the image so as to provide some redundancy.

In one embodiment of the first aspect, the system comprises image matching means, wherein the media file association means comprises the image and image matching means.

In one embodiment of the first aspect, the image matching means is configured to identify a match between the image and a reference image.

In one embodiment of the first aspect, the system comprises a server owned or administered by a system coordinating entity.

In one embodiment of the first aspect, the server is configured to extract from the image or receive from the device location information, or a proxy for location information for the associated media file from the image.

In one embodiment of the first aspect, the server comprises means for linking a proxy for location information to actual location information.

In one embodiment of the first aspect, the means for linking a proxy for location information to actual location information is a lookup table.

In one embodiment of the first aspect, the associated media file is transmitted to the device via the server.

In a second aspect of the present invention there is provided device application software configured to: receive or capture an image on a device, and analyse the image to detect or extract the location of a media file associated with the image, or a proxy for the location of a media file associated with the image, wherein the application is further configured to instigate the downloading or streaming of the media file to the device.

In a third aspect of the present invention there is provided a physical image having media file association means disposed on or about the image.

In one embodiment of the third aspect, the image is of photographic quality.

In one embodiment of the third aspect, the physical image comprises human comprehensible indicium identifying the photograph as being associated with a media file.

In one embodiment of the third aspect, the media file association means comprises the actual file location, or a proxy for the actual file location.

In one embodiment of the third aspect, the media file association means comprises a marking, graphic, letter or numeral visible to a human, the marking, graphic, letter or numeral being disposed on or about the image.

In one embodiment of the third aspect, the media file association means is a watermark disposed on or about the image.

In one embodiment of the third aspect, the watermark is substantially imperceptible to the unaided human eye.

In one embodiment of the third aspect, the media file association means is a series of markings deliberately disposed on the image for the purpose of encoding media file association information.

In one embodiment of the third aspect, the markings are printed in an ink capable of emitting or reflecting electromagnetic radiation of a wavelength outside the visible spectrum.

In one embodiment of the third aspect, the markings are repeated across the image so as to provide some redundancy.

In a fourth aspect there is provided by the present invention an electronic image file having media file association means encoded therein.

In one embodiment of the fourth aspect, the image encoded by the file is of photographic quality.

In one embodiment of the fourth aspect, the image encoded by the file comprises human comprehensible indicium identifying the photograph as being associated with a media file.

In one embodiment of the fourth aspect, the media file association means comprises the actual file location, or a proxy for the actual file location.

In one embodiment of the fourth aspect, the media file association means is embedded within the file structure of the electronic image file.

In a fifth aspect, the present invention provides a system comprising a physical image comprising media file association means encoding a proxy for a media file location, and means for linking the proxy for media file location for to an actual media file location.

In one embodiment of the fifth aspect, the means for linking the proxy for media file location information to an actual location information is a lookup table.

In a sixth aspect, the present invention provides a system comprising an electronic image file comprising media file association means encoding a proxy for a media file location, and means for linking the proxy for media file location for to an actual media file location.

In one embodiment of the sixth aspect, the means for linking the proxy for media file location information to an actual location information is a lookup table.

### BRIEF DESCRIPTION OF THE FIGURES

FIG. 1 shows is diagrammatic form an exemplary system of the present invention.

FIG. 2 shows user interface of a smartphone as a component of an exemplary system of the present invention, the interface showing the steps involved in capturing an image, recording an associated video file, applying a substantially imperceptible watermark to the captured image, and associating the video with the captured image.

FIG. 3 shows user interface of a smartphone as a component of an exemplary system of the present invention when in scanning mode allowing the user to automatically scan and redirect to the video source.

FIG. 4 shows user interface of a smartphone as a component of an exemplary system of the present invention when in gallery mode allowing the user to review captured images and associated videos.

FIG. 5 shows user interface of a smartphone as a component of an exemplary system of the present invention when in a mode allowing the user to generate an adhesive sticker which may be applied to a greeting card or other object.

FIG. 6A is a flow chart showing the method steps involved encoding an image file with a unique identifier, and returning the encoded image to the user, as used in exemplary embodiments of the present invention

FIG. 6B is a diagrammatic representation of an encoded image as used in exemplary embodiments of the present invention. The dotted circled region is an enlargement of a smaller area of the encoded image.

FIG. 6C is a flow chart showing the method steps involved in a recipient capturing an image file encoded with a unique identifier, and using the unique identifier to allow access of the recipient device to a media file associate with the encoded image, as used in exemplary embodiments of the present invention.

FIG. 7 is a diagrammatic representation of a system of a preferred embodiment of the invention.

### DETAILED DESCRIPTION OF THE INVENTION

Reference throughout this specification to “one embodiment” or “an embodiment” means that a particular feature, structure or characteristic described in connection with the embodiment is included in at least one embodiment of the present invention. Thus, appearances of the phrases “in one embodiment” or “in an embodiment” in various places throughout this specification are not necessarily all referring to the same embodiment, but may. Furthermore, the particular features, structures or characteristics may be combined in any suitable manner, as would be apparent to one of ordinary skill in the art from this disclosure, in one or more embodiments.

Similarly it should be appreciated that the description of exemplary embodiments of the invention, various features of the invention are sometimes grouped together in a single embodiment, figure, or description thereof for the purpose of streamlining the disclosure and aiding in the understanding of one or more of the various inventive aspects. This method of disclosure, however, is not to be interpreted as reflecting an intention that the claimed invention requires more features than are expressly recited in each claim. Rather, as the following claims reflect, inventive aspects lie in less than all features of a single foregoing disclosed embodiment. Thus, the claims following the Detailed Description are hereby expressly incorporated into this Detailed Description, with each claim standing on its own as a separate embodiment of this invention.

Furthermore, while some embodiments described herein include some but not other features included in other embodiments, combinations of features of different embodiments are meant to be within the scope of the invention, and from different embodiments, as would be understood by those in the art.

In the claims below and the description herein, any one of the terms “comprising”, “comprised of” or “which comprises” is an open term that means including at least the elements/features that follow, but not excluding others. Thus, the term comprising, when used in the claims, should not be interpreted as being limitative to the means or elements or steps listed thereafter. For example, the scope of the expression a method comprising step A and step B should not be limited to methods consisting only of methods A and B. Any one of the terms “including” or “which includes” or “that includes” as used herein is also an open term that also means including at least the elements/features that follow the term, but not excluding others. Thus, “including” is synonymous with and means “comprising”.

It will be understood that not all embodiments of the invention provide all advantages. Some embodiments may have a single advantage and others may have no advantage over the prior art and merely represent a useful alternative to the prior art.

The present invention is predicated at least in part on Applicant's finding that an image or graphic (whether in hard copy or displayed on a screen or in the form of an electronic image file, or a a frame of a video) may be utilised as an invitation for a viewer of the image to access a media file, and furthermore for the image to act as a means for the viewer to gain access to the media file. Accordingly, in a first aspect the present invention provides a system for transmitting electronic video and/or audio to a device, the system comprising: an image comprising media file association means, electronic storage means comprising a media file, a device configured to receive the image or to capture the image, the device being in operable connection with the electronic storage means, wherein upon download or capture of image by the device, the electronic audio or video is transmitted to the device.

The use of an image (still or moving) can act as an invitation for a viewer to access further pre-recorded video and/or audio content in relation to the subject matter of the image. The video and/or audio content may be streamed directly to the device, stored on the device for later review, or the viewer may be directed to a web page where the content is otherwise accessible. Thus, the image may act in some way to describe or allude to the subject matter of the audio and/or video file. For example, the image may be a photograph depicting a birthday party scene having identifiable members of the viewer's family present. This image informs the viewer that any associated media file is likely to be a movie file of the family members singing “Happy Birthday”.

Having simply viewed the image, the viewer has not been compelled at that point to download the movie file, or to stream the movie file on his/her device. However upon some action taken by the viewer (such as clicking the image or capturing the image on a camera), the movie file is downloaded or streamed to the viewer's device. Upon clicking the image, the file association means of the system is triggered so as to provide the viewer's device with the location of the movie file (which may be stored on a cloud server) and commence downloading or streaming the movie file to the device.

It will be understood that the image and/or the associated media file is/are typically generated by a first party user inviting a second party viewer to consume the content of the media file. The image may be a physical (hard copy) image such as a family photograph or a photograph of a house for sale on a realtor's sales board, or a graphic such as a cartoon, or an electronic image presented on an electronic display such as a smart phone screen.

The image may be selected so as to garner the attention of a viewer and/or provide some information on the subject matter of media file. The image preferably has photographic qualities such as continuous tones, and at least provide the level of detail provided in at least 8 bit, 16 bit or 24 bit electronic image files. Use of images having photographic qualities provides advantage in the art in so far as detailed information that is easily comprehensible by a viewer may be conveyed. Such information may make the viewer more likely to consume the content of the media file, or at least provide sufficient information to allow the viewer to make an informed decision as to whether or not the subject matter of the media file is of sufficient interest to consume.

For example, the image may provide sufficient detail so as to allow a viewer to recognise any person in the image known to them. Where the image contains a recognisable face of a close family member the viewer may be more likely to have interest in the media content and consume same. Conversely, where the image contains the recognisable face of a work colleague, the level of interest may be low and so the viewer is less likely to consume the media file content.

As another example, the image may depict a consumer product, such as a car displayed in a magazine, with there being sufficient detail in the image so as to inform at least if the car is a family vehicle or a pick-up truck. The former type of vehicle may be of interest to the viewer, while the viewer may have no interest in the latter.

The image may be a still image or a moving image presented on a television, computer screen or cinema screen. The still or moving image may advertise a consumer product or service. The resolution of such image presentation means is sufficient so as to present an image with sufficient detail so as to garner the interest of a potential customer.

In other embodiments, the image depicted by the image does not resemble any person or object or scene or sound represented in the media file, or to otherwise identify any person or object or scene or sound represented in the media file. Expressed another way, the image depicted by the image resembles any person or object or scene or sound not represented in the media file, or otherwise identifies a person or object or scene or sound not represented in the media file. Such embodiments may be used for comedic or surprise value, given the transmission of a media file that is unexpected by a recipient. For example the image may depict a scene of an elderly person sitting quietly reading a book, while the associate media file may be a video of a scene from a loud party held by a user. The recipient is caused to laugh by the contradiction in the two scenes.

In some embodiments, the image of the present system provides a higher level of detail greater than that of a simple 1 bit monochrome image as used in bar codes, QR codes and the like. Such codes fail to provide any meaningful invitation to access any media file, much less any information pertaining to the subject matter of the media file. Moreover, a bar codes or QR code is applied to an image (or applied proximal to an image) is a significant visual distraction to a viewer. In some cases, the code may need to be of very large size (relative to the image) so as to be comprehensible to a reader and may indeed obscure some information of the image.

As will be appreciated, a person is constantly presented with images when browsing the Internet, watching television, reviewing social media content, reading magazines, viewing family photographs or viewing roadside advertisements. To discern from images with no associated media file, an image of the present system may comprise an indicium such as visible mark, word, or graphic configured to identify the image as one having an associated media file. In the exemplary embodiments disclosed herein infra, a “QV” logo is disposed in the image so as to alert a viewer than an associated media file is available for consumption. Typically, the indicium is configured so as to stand out against many different types of images and will generally comprise high contrast elements and/or block elements of color to draw the user's attention. The indicium will generally be disposed in a peripheral area and sized accordingly so as to avoid detracting from the image upon which it is disposed. Such indicium may be discrete, or may be in the form of a frame surrounding an image.

In some embodiments, the indicium also comprises the media file association means (such as a substantially imperceptible watermark). As will be appreciated, a watermark which is otherwise substantially imperceptible may become perceptible against a uniform background, and the indicium may be required to be appropriately configured (whether by the use of color, shading, complex imagery or graphics etc) so as to be capable of concealing any watermark.

The image of the system comprises file association means. The file association means may comprise any computer-readable information that allows for the media file associated with the image to be located. The information may be coded in any form, such as written form (such as numbers of letters) and/or graphical form (such as by a shape, color, or relative disposition of graphical elements). In one form of the system, the file association means may be a simple bar code or QR disposed on the image or proximal to the image. While operable in the context of the present system, such visible codes are generally less preferred because of the visual disturbance caused to the image.

In preferred embodiments of the system, the file association means is not visible or not easily visible to the human eye. The information encoded in the file association means may be readable on the viewer's device upon download of an image file, or by the capturing of the image by a camera of the user's device.

In one embodiment, the file association means invisibly encodes information by steganographic means. In digital steganography, electronic communications may include steganographic coding inside of a transport layer, such as an image file, program or protocol. For example, a starting image may be encoded with information by adjusting the color of every 100th pixel to correspond to a letter in the alphabet, such change being generally imperceptible to a human. In some embodiments, the information encoded may be readable only where the image is in the form of a downloaded electronic image file. In other embodiments, more gross changes may be made so as to encode information in the image. Such gross changes may be device-detectable such that where the image is digitally photographed (and with sufficiently high resolution) the digital image file is analysable so as to extract any encoded information.

In other embodiments, the file association means is a substantially imperceptible watermark, or a watermark of low visibility. The information in the watermark may be readable from a downloaded electronic image file or from a photograph taken of an invisibly watermarked image.

The watermark may also be readable from a still or moving image presented on a television screen, a computer screen or a cinema screen. A television advertisement is typically of very limited duration (typically 15 seconds or 30 seconds) and therefore incapable of imparting detailed product information. The present invention allows for a viewer to capture a television image (still or moving) on a smartphone, and be directed via the media file association means (for example a visible or invisible watermark in the captured image) to electronic audio or video that is remotely stored and streamed to the smartphone. The advertiser can therefore impart further product details (in the form of audio, video, or text) to the viewer, and in a manner that is virtually instantaneous. In some circumstances, the viewer is directed to a web page where the further audio, video or text is accessible.

The watermarking may be embodied in the form of spatial domain water marking (including least significant bit and patchwork techniques) or frequency domain watermarking (including discrete cosine transformation and discrete wavelet transformation techniques).

In embedding a digital watermark into an image, an algorithm may accept the host (the image) and the data to be embedded (the location of the associate media file, or at least a proxy for the location information). Inputs to the scheme are typically the watermark (the encoded information), the cover data, and optionally a public or private key. An exemplary algorithm is the Fast Hadamard Transform.

Extraction of the encoded location information in the image is typically by way of an extraction algorithm which is applied to the downloaded or captured image. Inputs to the scheme are the watermark (the encoded information) and optionally the key. The Fast Hadamard

Transform algorithm (applied in inverse) may be used in this regard. Application of the substantially imperceptible watermark may be achieved by proprietary means such as provided by Digimarc Corporation (Beaver, Oreg., United States). For example, the product “Digimarc for Images” may be used to embed digital watermarks into images for persistent and unobtrusive encoding of copyright and ownership information. Such information may be replaced by information configured to allow a device of the viewer to access an associated media file. In some circumstances (for example, against a plain background) the altered pixels of a digital watermark applied using the Digimarc product may be visible, especially where the image is magnified.

Means for encoding information in the images of the present system does not necessarily need to provide any high level of security. It is unlikely that any third party would make an unauthorised copy of the image, and even if that were to occur, the author of the image is unlikely to be concerned. Thus, the means for encoding information by watermarking does not need to be particularly robust or provide any defence to tampering or removal.

The means for encoding media file association information in the images may take the form of a series of markings (such as dots, or squares) which are presented on a printed version of the image. Each of the markings may be so small so as to be visually imperceptible, or at least difficult for a normally-sighted person to perceive. The markings may be distributed across an area, and being relatively well separated so as to lower perceptibility. The marking may have a partly defined formation which is always present, detection of this formation being indicative to a device capturing the image that an encoded media file association means is present on the image. For example, the defined formation may describe a square border (which is invariable), with the encoded information (which is variable) being disposed within the border.

In some embodiments, the markings are substantially invisible and may be configured to be readable only by optical means capable of detecting electromagnetic radiation outsight the visible light spectrum. For example, it is know that a smart phone camera may detect radiation outside the visible spectrum, with this ability being exploited by the present invention. The markings may emit or reflect light in longer wavelengths (such as infrared and longer) or in shorter wavelengths (such as ultra violet and shorter).

Certain inkjet printer inks (or combinations of inks) can emit or reflect radiation outside the visible spectrum. Thus, a physical image printed with such inks when exposed to normal (visible) light may emit or reflect markings deliberately disposed on the printed image for the purpose of encoding media file association information outside the visible spectrum. The device of the system configured to capture the image may comprise software means to filter out radiation outside the wavelength band of interest so as to remove potentially interfering markings that have not been deliberately disposed for the purpose of encoding media file association information.

The marking may be repeated across the image so as to provide some redundancy. In this way, a user does not need to capture the entire image to be certain that all necessary marking have been captured. For example the markings may be disposed along multiple parallel vertical axes, the markings along one axis being identical to the markings on a neighbouring axis.

In one embodiment, the image itself (in non-watermarked form) may be utilized by system so as to provide the location of a media file associated with the image. In accordance with this embodiment, it will be appreciated that images (apart from precise copies) will have gross differences (such as an image of a man compared with an image of a cat) and finer differences (such as slight variations in pixel data for any given pixel in an image of fixed dimension). Thus, a user may provide image according to the present system and also an associated media file. The system may be configured to define the uploaded image as a reference image against which query images are compared with the aim of matching the query image to a reference image. Thus, a query image may be a downloaded image or captured image for which a view of that image is seeking the associated media file. The query image is compared with a plurality of reference images until a match is found. The matched reference image has associated media file location information, with the media file then streamed or download by the user. In this way, it will be appreciated that no watermark is required. Of course, this embodiment requires that a user previously uploads an image for use as the reference image as well as the associated media file.

The query image is compared with reference images of the system database. The images may be compared by any method known to the skilled person. As will be appreciated, accuracy of the image comparison method used will determine to a large part whether or not an authentic match is found. A further issue is that of speed, with system users typically preferring real time, or almost real time response to a request for a media file.

Useful object recognition methods used for image matching include geometric methods based on CAD-like object models (comprising edge detection or primal sketch methods), appearance-based methods (comprising edge matching methods such as Canny edge detection, divide-and-conquer methods, greyscale matching methods, gradient matching methods, histogram of receptive filed response methods, or model base methods using eigenfaces.

In one embodiment of the system, a feature-based method is used in the comparison of query images and reference images. The aim of such methods is to identify a feasible match between and object features and image features. A typical primary constraint use in feature-based methods is that a single feature from the object to be recognized must account for all or most of the feasible matches. Methods for extraction of features from objects to be recognized and the reference images include surface patches, corners and linear edges.

In searching for feasible matches, an interpretation tree may be utilized. In such embodiments, the root node represents and empty set, and each other node is the union of the matches in the parent node and one additional match. A “wildcard” is used for features with no match. Nodes are cut when the set of matches is infeasible.

In one embodiment of the system or method, a “hypothesize and test” method is used in the comparison of query images and reference images. Such methods rely on the general approach of hypothesizing a correspondence between a collection of reference image features and a collection of object features, and then use this to generate a hypothesis about the projection from the object coordinate frame to the image frame. This projection hypothesis is used to generate a rendering of the object (termed “backprojection”). Then follows the step of comparing the rendering to the reference image, and if the two are sufficiently similar, accept the hypothesis

A variety of means for generating hypotheses are available to the skilled person. For example, where camera intrinsic parameters are known, the hypothesis is equivalent to a hypothetical position and orientation (pose) for the object. Geometric constraints may be utilized to construct a correspondence for small sets of object features to every correctly sized subset of image points.

In one embodiment of the system or method, a pose consistency method is used in the comparison of query images and reference images. This method is also term “alignment” since the object is aligned to the reference image. Generally, correspondences between image features and model features are considered not independent. A small number of correspondences yield the object position, and the other correspondences must be consistent. The principle is that a match is hypothesized between a large group of image features and a large group of object features, then the missing camera parameters can be recovered and so render the rest of the object. Hypotheses are generated using small number of correspondences (e.g. triples of points for 3D recognition). Other model features are back-projected into the image and additional correspondences verified. In this method, the smallest number of correspondences necessary to achieve discrete object poses are used.

In one embodiment of the system or method, a pose clustering method is used in the comparison of query images and reference images. The principle of this method is that each object leads to many correct sets of correspondences, each of which has (approximately) the same pose. A vote on pose is performed using an accumulator array that represents pose space for each object. For each object, an accumulator array that represents pose space is set up—each element in the accumulator array corresponds to a “bucket” in pose space. Each image in frame group is then taken, and a hypothesis formed relating to correspondence between it and every frame group on every object. For each of these correspondences, pose parameters are determined and an entry made in the accumulator array for the current object at the pose value. Where there are large numbers of votes in any object's accumulator array, this can be interpreted as evidence for the presence of that object at that pose. The evidence may be checked using a verification method.

In one embodiment of the system or method, an invariance method is used in the comparison of query images and reference images. This method relies on the presence of geometric properties that are invariant to camera transformations, and is therefore applicable only to certain circumstances.

In one embodiment of the system or method, a geometric hashing method is used in the comparison of query images and reference images. This method utilizes an algorithm reliant on geometric invariants to vote for object hypotheses. It is similar to pose clustering methods, except that rather than voting on pose, there is voting on geometry.

In one embodiment of the system or method, a scale-invariant features transform (SIFT) method is used in the comparison of query images and reference images. By this method, keypoints of objects are first extracted from reference images and stored in the database.

An object and image are individually compared feature-by-feature and finding candidate matching features based on Euclidean distance of their feature vectors.

SIFT keypoints of objects are extracted from the reference images of the database and stored in the database. From the full set of matches, subsets of keypoints that agree on the object and its location, scale, and orientation in the new image are identified to filter out good matches. The determination of consistent clusters is performed rapidly by using an efficient hash table implementation of the generalized Hough transform. Each cluster of 3 or more features that agree on an object and its pose is then subject to further detailed model verification and subsequently outliers are discarded. Finally the probability that a particular set of features indicates the presence of an object is computed, given the accuracy of fit and number of probable false matches. Object matches that pass all these tests can be identified as correct with high confidence. Further detail of the incorporation of SIFT methods into the present methods and systems are found herein with reference to the preferred embodiments.

For any feature-based method (including SIFT) putative comparison-relevant features (such as vectors) are extracted from the query digital image file, and also the reference image file. The vectors may be a point in a high dimensional domain.

In one embodiment of the system or method, a Speed Up Robust Features (SURF) method is used in the comparison of query images and reference images. This method uses an integer approximation to the determinant of Hessian blob detector, which can be computed rapidly with an integral image (3 integer operations). For features, it uses the sum of the Haar wavelet response around the point of interest. Again, these can be computed with the aid of the integral image. This information is treated to perform operations such as recognition of certain objects, people or faces, and extraction of points of interest.

In one embodiment, the number of vector elements is configurable and is set to a minimum number, and preferably at least about 2, 4, 8, 16, 32, 64, 128, 256, 512, 1024, 2048 or 4096. The range of values for a vector are typically normalized between −1 and 1. It will be appreciated that more than one comparison method may be used to improve accuracy. For example, a SIFT and SURF method may be used in combination.

Once the closest reference image is identified, the system extracts the associated media file location data in linked association with the image.

The information encoded in the image may be in no way related to the visual appearance of objects in the image, and may instead be a “numerical fingerprint” of the image. For example, a unique identifier of the image may be generated (which may be used by the system as a proxy for the location of the associated media) by a combination of numerical features of the image. Typically, several numerical features at least may be required to provide sufficient ability to function as a unique identifier. Suitable numerical features may include (i) the percentage of pixels having a certain minimum brightness in each of the three color channels (red, green, blue) (ii) the percentage of pixels having a certain maximum brightness in each of the three color channels, (iii) the numerical proportion of the pixels which are substantially black, the absolute number of pixels which are substantially white, etc.

The association means of the image file may be an identifier written into one or more bytes of the image file. For example, the image file may have associated file information that can be exploited to encode an identifier. Many image file formats support metadata standards, with the bytes allocated to metadata being a useful “place card” to insert an identifier which electronically points to an associated media file. Such metadata standards include EXIF, GPS, IPTC, XMP, and Maker

Taking a *.jpg file to demonstrate this approach, it will be noted that bytes used to hold file information that may be exploited include EXIF metadata such as “shot”, “ISO”, “Device”, “Source” and “Location”.

The skilled person is enabled to alter metadata-associated bytes. Indeed, consumer-level software is available to edit image metadata, including Daminion™, DB Gallery™, and Exif Pilot™.

In some embodiments, bytes which actually encode the image (such as the pixel-related information) are exploited to encode the identifier. While the encoding of any identifier in these bytes may alter the appearance of an image, it is preferred that such alterations are minimal or even invisible to a viewer. The ability of a smartphone camera to reveal greater detail and detect light having wavelengths outside the human-visible spectrum is exploited in this regard.

The identifier may be encoded in any unused or redundant bytes of the image file.

The identifier may be encoded by methods that do not rely on the standard format of an image file. One means of achieving encoding by such methods is the use of a sidecar file or a container file associated with the image file. The bytes of a sidecar file or a container file may be encoded with an identifier which electronically points to a media file.

Where the image is a printed image and disposed in a fixed location (for example, a billboard) the identifier may provide location-specific information. This allows for an advertiser to determine the number of times an image is captured and a video or audio advertisement is streamed to a user. The advertiser can thereby compare the effectiveness of advertising in a particular location, as compared with other locations. For example, a billboard may be displayed at three different locations with the image to be captured on each billboard having a different identifier. Each of the three identifiers corresponds to one of the three locations, and all three identifiers when captured triggers streaming of the same video or audio advertisement to the user. When a user captures the first identifier, the system records the identifier and by way of a look up table in a database of the system associates that capture with the first location. When a user captures the second identifier, the system records the identifier and by way of a look up table in a database of the system associates that capture with the second location, and similarly for the third identifier/location combination.

A server streaming the video or audio advertisement may be configured to track the number of times each image is captured for each location and content streamed to the user device. This information may be embodied in an electronic report, such as by way of graphical means or spread sheet means.

As an alternative to using unique identifiers for each billboard location, a single identifier may be used across multiple locations. In this circumstance, location information obtained from the capture device (which is typically a GPS-enabled smart phone) may be exploited. By software means of the capture device, location information is retrieved at the time of capture. The software means may be configured to read the device location at the time of capture and transmit the information to the content streaming server for recordal. Thus, the server may be configured to provide an electronic report disclosing the GPS location at capture, and collation of similar locations so as to provide an advertiser with information detailing the number of time that a billboard in a given location is captured.

The advertising industry also places significant value on demographic information. Thus, an advertiser will typically wish to have information on the persons viewing an advertisement. Thus, in some embodiments the present systems comprise means for obtaining demographic information from a device user who has captured an image. Thus, the user device may comprise software means configured to obtain demographic information and report that information to a remote server (such as the server which streams the audio or video advertisement). The demographic information may be provided to an advertiser by way of an electronic report. Useful demographic information includes sex, age, educational level, occupation, home ownership, place of residence, income, marital status, number of children, employment status, types of transport used, pet ownership, nationality, political affiliation, and religious affiliation. Software means of the user device may be configured to obtain demographic information and optionally combine with location information as disclosed supra. The software means may also fulfil the functions of executing the image capture and playing the streamed video or audio advertisement to the user.

In some embodiments the software means is embodied in the form of an app (such as iOS or Android executable), and the app may comprise a user interface prompting for the input of demographic data upon installation. This demographic information would then be electronically tagged to each advertisement streaming session to provide an advertiser with powerful data detailing the type of persons that are attracted to the image that was captured. Furthermore, information on whether or not the entire audio or video advertisement was stream may be incorporated into the tag.

To be approved for the Apple App Store™ or Google Play™, an app may not be permitted to present a user interface which prompts for input of demographic information. As will be understood, these are matters of company policy as distinct from any technical or legal bar preventing configuration of application software to prompt for input of demographic information. In any event, the system may be configure alternatively to obtain and transmit such information. As one example, the audio or video advertisement streamed to the user may provide a motivation for the user to provide demographic data by a non-app channel. The app interface may (after an image is captured) provide a link to an external website whereby the user may input demographic information. Preferably, some motivation is provided for the user to take the trouble to provide the information, and with that in mind the link may be presented on the user interface as an invitation to gain a benefit or a perceived benefit of some type. The benefit may be a free or discounted good, a free of discounted service or entry into a competition. In order to receive the benefit the user must provide requested demographic information by way of user interface presented at the linked website. The demographic information may then be transmitted (along with any location information) to the advertiser in electronic report form.

In any event, the file association means (however provided) may be capable of encoding sufficient information so as to uniquely identify a large number of images. Such capability is required so as the system is workable with a plurality of users, with each user having a plurality of images and associated media files. In one embodiment, the file association means is capable of encoding sufficient information so as to uniquely identify at least about 10⁵, 10⁶, 10⁷, 10⁸, 10⁹, 10¹⁰, 10¹¹, or 10¹² different images.

In some embodiments, the system is configured so as require the unique identification of an image amongst all images of a single user, there being means in the system such that the media files of a certain user are only available for download or streaming. In such cases, the file association means may be capable of encoding sufficient information so as to uniquely identify only about 10³, 10⁴, or 10⁵ different images of a single user.

The encoded information may refer directly to a media file location (one example being a share URL). More typically, the encoded information is a proxy for the media file location information. For example, the encoded proxy may be a simple string of six letters (providing more than 3 billion unique identifiers), such as “AFBCDS”. The proxy AFBCDS is included in a lookup table (along with many other proxies) as constructed and maintained by a system administrator and typically maintained on a database of a cloud server. The lookup table for proxy AFBCDS provides the location for the associated media file.

In one embodiment of the system, the media file associated with an image is stored on a media file server associated with the user (i.e. the party who has generated the media file and wishes to transmit that file to a recipient with a potential interest in consuming the content). For added security, the associated media file is stored on a secure file sharing server which is generally inaccessible by members of the public. The file sharing server may be owned or administered by the user, or by a third party charged with administering the present system. Preferably, the file sharing server is a dedicated commercial file sharing server, and more preferably not owned or administered by any entity charged with administering the present system, or any entity associated with. The server may have the ability to password protect the associated media files. Potentially useful file sharing servers include online cloud storage services such as Dropbox™, Google Drive™, MediaFire™, RapidShare™, ShareFile™, Box™, and SugarSync™ and the like.

In some embodiments of the invention, application software on a user device configured to perform various functions such as image capture and media file streaming (as described elsewhere herein) is configured to prompt a user to set up a cloud storage account, or may automatically set up a cloud storage account based on user details. The user details (such as username, password etc.) will typically be provided by the user in the course of an initial registration of the application software. This cloud storage service will then be used by default to store media files which can be associated with an image taken by the device camera, or an image obtained by some other means. Thus, in some embodiments the system comprises a cloud storage server in operable communication with the device.

As will be appreciated from the above, the present system may be administered by a dedicated entity, or by a social media entity, or by some other third party. In any event, the administering entity will typically own or administer a computer server capable of performing functions such as receiving input images and associated media files from user devices, processing queries from viewers of the images and transmitting the associated media file to the viewer's device, generating and maintaining lookup tables linking image proxies and locations for associated media files, maintaining user accounts, and the like. This server may comprise all means (software and hardware) allowing for the upload of images, algorithmic means embedded in software form for extracting media file location or a proxy from an image, retrieving a media file from a remote media file server and the like.

As will be appreciated after having the benefit of the present specification, the invention defined herein will find utility in many fields of endeavour. Once field will be that of social media where a user may post an image on a service such as an facebook™, lnstagram™, or Twitter™ with the user having also prepared an associated movie file. The image will have an indicium which is recognisable by a viewer of the image to indicate that an associated media file is available for download or streaming. The image acts as an invitation to a viewer to consume the media file content, and if sufficiently interested to do so the viewer will typically click on the image to commence streaming of the media file.

As one example of such an application would be in combination with a facebook™ “wall” whereby an image may be displayed on a user's wall with the image having media file association means. Upon clicking the image a media file is streamed to the person viewing the wall. In this circumstance, the media file may not be hosted by facebook™, and is instead stored on a server which is owned or administered by a third party entity. The third party entity may be a cloud storage server such as Dropbox™ or Google Drive™. Cloud storage services typically allow users to store in a secure and password protected manner relatively large files such as video files. An advantage is provided in that the user is not forced to rely on the security of any social media provider for uploaded video files and can instead select a cloud storage provider of choice. Moreover, the cloud storage provider can be used as a central means of storage which may act as a library which can be pointed to from multiple social media websites, or indeed any other connected computer.

The invention may have use in commerce in the marketing of goods or services to potential customers. Such uses are discussed supra. As a further exemplary commercial embodiment, the system may be used by a realtor in order to transmit further media information to a potential property buyer. The potential buyer may be driving past a property for sale and be enticed to seek further information by directing the camera on his smartphone on one of the photographs on a sales board erected in the front yard of the property. The buyer may be particularly interested in a photograph of the rear year of the property and capture that photograph. An embedded substantially imperceptible watermark on that photograph triggers the system to play a short video showing further features of the yard such as children playing on an installed trampoline, an outdoor entertaining area being used for a BBQ, and the inside of a garage. Capturing a photograph of the kitchen may launch a 3D virtual tour of the kitchen allowing the user to fully appreciate the room, and also the connection with adjoin rooms.

Photographs in magazines, brochures, newspapers, and the like may be captured by a viewer's smartphone thereby triggering the streaming of video or audio relating to a product or news story.

As a further example of a non-commercial embodiment, a wife leaving for an overseas business trip may take a digital photograph of her face, embed a substantially imperceptible watermark, and leave the photograph on her husband's bedside table. While the husband is sleeping and the wife (being in a different time zone) is at the end the end of her working day and uploads a video detailing some interesting events of the day. Upon waking, the husband is reminded by the photograph to check for any video messages from his wife. He aims the camera of his smartphone at the photograph and immediately upon detection of the substantially imperceptible watermark the smartphone commences to play the video message left overnight by the wife.

As a further example for personal use (and optionally private use), the system may be used to index a series of video or audio media files covering activities such as a holiday or a wedding. In this embodiment, the image may be a photograph taken by a user and the associated media file also being recorded by the user. The user could be at a landmark site in the course of a tour, and then taking a digital photographic image of the landmark with a smart phone. The digital image file then (by software means of the smart phone) has media file association means embedded therein. The user then records a video of the scene around the landmark, possibly depicting friends accompanying the user on tour or a short presentation relating to the landmark given by a tour guide. The video is electronically linked to the image by way of the media file association means embedded in the image file, which may be an alphanumerical identifier inserted into an EXIF field of the image file. The link to the associated video may be provided by way of an entry in a relational database of the type well known to the skilled person, and whereby the alphanumerical identifier is electronically linked to the video. The identifier and the file name of the associate media file may be linked in this way.

When the user returns from the tour, the images can be viewed as an ordered grid of images on a device screen. The images act as a visual index for the series of videos that are associated with each image. The first image may show the Eiffel Tower, and upon clicking that image the computing device upon which the image is displayed can access (via software means) the embedded identifier. In turn, the identifier (by way of a relation database resident on or accessible to the displaying device) is used to locate the associated video, and the video is then played to the user.

The video may be taken with a view to providing for better context of the original image taken. Alternatively, the original image may be taken as an index image to assist a person to locate a desired video.

From the above, it will be clear that the image of the system may be captured by the user, or may be obtained from some other source. Moreover, the associated media file of the system may be captured by the user, or may be obtained from some other source.

In some embodiments of the invention, the recipient of an associated media file is permitted either (i) a predetermined number of views of the file contents, or (ii) access to the file contents for a maximum time period. These permissions will typically be set by the user that provides the image and associated media file, generally by way of application software of the user's device. For example, the user may allow a recipient to view an associated video once, twice or a maximum of ten views. Alternatively, the user may allow a user access for 10 minutes, 30 minutes or one hour or one day from the initial viewing. Alternatively, the user may set a cut-off time and date after which the file contents are not viewable, and/or a commencement time and date from which the file contents are viewable. These parameters are controllable given that access of an associated media file by a recipient may be governed by a server (which is not a media server) to which the recipient device must connect in order to access files from a media server. Thus, the media file may stream from a cloud storage server, via an access governing server to the recipient device. Thus, the access governing server may keep track of the number of times a given recipient has accessed the associated media file, or the time and date of a recipient request to access a media file and allow (or deny) access to a media file depending on the user permissions sent.

As an alternative, application software of the recipient's device may be configured to be the only means by which the media file can be streamed, and the decision whether or not to allow access is made on the recipient's device and in light of permissions which have been previously transmitted to it.

The present system has been described mainly by reference to a device being a smartphone. Of course, other operable devices include a tablet, a phablet, a laptop computer, a notebook computer, a desktop computer or some other custom designed device configured to achieve the functions herein.

The application software of the present invention may be executable on any past, present or future operating system of a mobile communication device including Android™, iOS™, Windows™, Linux™ and the like.

In the present systems, any of the devices or servers may comprise network interface means configured to interface with other components of the system. The network interface means typically routes data into and out of a system component.

The methods and systems described herein may be deployed in part or in whole through one or more processors that execute computer software, program codes, and/or instructions on a processor. The processor may be part of a server, client, network infrastructure, mobile computing platform, stationary computing platform, or other computing platform. A processor may be any kind of computational or processing device capable of executing program instructions, codes, binary instructions and the like. The processor may be or may include a signal processor, digital processor, embedded processor, microprocessor or any variant such as a coprocessor (math co-processor, graphic co-processor, communication co-processor and the like) and the like that may directly or indirectly facilitate execution of program code or program instructions stored thereon. In addition, the processor may enable execution of multiple programs, threads, and codes.

The threads may be executed simultaneously to enhance the performance of the processor and to facilitate simultaneous operations of the application. By way of implementation, methods, program codes, program instructions and the like described herein may be implemented in one or more thread. The thread may spawn other threads that may have assigned priorities associated with them; the processor may execute these threads based on priority or any other order based on instructions provided in the program code. The processor may include memory that stores methods, codes, instructions and programs as described herein and elsewhere.

Any processor or a mobile communication device or server may access a storage medium through an interface that may store methods, codes, and instructions as described herein and elsewhere. The storage medium associated with the processor for storing methods, programs, codes, program instructions or other type of instructions capable of being executed by the computing or processing device may include but may not be limited to one or more of a CD-ROM, DVD, memory, hard disk, flash drive, RAM, ROM, cache and the like.

A processor may include one or more cores that may enhance speed and performance of a multiprocessor. In some embodiments, the processor may be a dual core processor, quad core processors, other chip-level multiprocessor and the like that combine two or more independent cores (called a die).

The methods and systems described herein may be deployed in part or in whole through one or more hardware components that execute software on a server, client, firewall, gateway, hub, router, or other such computer and/or networking hardware. The software program may be associated with a server that may include a file server, print server, domain server, internet server, intranet server and other variants such as secondary server, host server, distributed server and the like. The server may include one or more of memories, processors, computer readable media, storage media, ports (physical and virtual), communication devices, and interfaces capable of accessing other servers, clients, computers, and devices through a wired or a wireless medium, and the like. The methods, programs or codes as described herein and elsewhere may be executed by the server. In addition, other devices required for execution of methods as described in this application may be considered as a part of the infrastructure associated with the server.

The server may provide an interface to other devices including, without limitation, clients, other servers, printers, database servers, print servers, file servers, communication servers, distributed servers and the like. Additionally, this coupling and/or connection may facilitate remote execution of program across the network. The networking of some or all of these devices may facilitate parallel processing of a program or method at one or more location without deviating from the scope of the invention. In addition, any of the devices attached to the server through an interface may include at least one storage medium capable of storing methods, programs, code and/or instructions. A central repository may provide program instructions to be executed on different devices. In this implementation, the remote repository may act as a storage medium for program code, instructions, and programs.

The software program may be associated with a client that may include a file client, print client, domain client, internet client, intranet client and other variants such as secondary client, host client, distributed client and the like. The client may include one or more of memories, processors, computer readable media, storage media, ports (physical and virtual), communication devices, and interfaces capable of accessing other clients, servers, computers, and devices through a wired or a wireless medium, and the like. The methods, programs or codes as described herein and elsewhere may be executed by the client. In addition, other devices required for execution of methods as described in this application may be considered as a part of the infrastructure associated with the client.

The client may provide an interface to other devices including, without limitation, servers, other clients, printers, database servers, print servers, file servers, communication servers, distributed servers and the like. Additionally, this coupling and/or connection may facilitate remote execution of program across the network. The networking of some or all of these devices may facilitate parallel processing of a program or method at one or more location without deviating from the scope of the invention. In addition, any of the devices attached to the client through an interface may include at least one storage medium capable of storing methods, programs, applications, code and/or instructions. A central repository may provide program instructions to be executed on different devices. In this implementation, the remote repository may act as a storage medium for program code, instructions, and programs.

The methods and systems described herein may be deployed in part or in whole through network infrastructures. The network infrastructure may include elements such as computing devices, servers, routers, hubs, firewalls, clients, personal computers, communication devices, routing devices and other active and passive devices, modules and/or components as known in the art. The computing and/or non-computing device(s) associated with the network infrastructure may include, apart from other components, a storage medium such as flash memory, buffer, stack, RAM, ROM and the like. The processes, methods, program codes, instructions described herein and elsewhere may be executed by one or more of the network infrastructural elements.

The methods, program codes, calculations, algorithms, and instructions described herein may be implemented on a cellular network having multiple cells. The cellular network may either be frequency division multiple access (FDMA) network or code division multiple access (CDMA) network. The cellular network may include mobile devices, cell sites, base stations, repeaters, antennas, towers, and the like. The cell network may be a GSM, GPRS, 3G, 4G, EVDO, mesh, or other networks types.

The methods, programs codes, calculations, algorithms and instructions described herein may be implemented on or through mobile devices. The mobile devices may include navigation devices, cell phones, mobile phones, mobile personal digital assistants, laptops, palmtops, netbooks, pagers, electronic books readers, music players and the like. These devices may include, apart from other components, a storage medium such as a flash memory, buffer, RAM, ROM and one or more computing devices. The computing devices associated with mobile devices may be enabled to execute program codes, methods, and instructions stored thereon.

Alternatively, the mobile devices may be configured to execute instructions in collaboration with other devices. The mobile devices may communicate with base stations interfaced with servers and configured to execute program codes. The mobile devices may communicate on a peer to peer network, mesh network, or other communications network. The program code may be stored on the storage medium associated with the server and executed by a computing device embedded within the server. The base station may include a computing device and a storage medium. The storage device may store program codes and instructions executed by the computing devices associated with the base station.

The computer software, program codes, and/or instructions may be stored and/or accessed on computer readable media that may include: computer components, devices, and recording media that retain digital data used for computing for some interval of time; semiconductor storage known as random access memory (RAM); mass storage typically for more permanent storage, such as optical discs, forms of magnetic storage like hard disks, tapes, drums, cards and other types; processor registers, cache memory, volatile memory, non-volatile memory; optical storage such as CD, DVD; removable media such as flash memory (e.g. USB sticks or keys), floppy disks, magnetic tape, paper tape, punch cards, standalone RAM disks. Zip drives, removable mass storage, off-line, and the like; other computer memory such as dynamic memory, static memory, read/write storage, mutable storage, read only, random access, sequential access, location addressable, file addressable, content addressable, network attached storage, storage area network, bar codes, magnetic ink, and the like. The methods and systems described herein may transform physical and/or or intangible items from one state to another. The methods and systems described herein may also transform data representing physical and/or intangible items from one state to another.

The elements described and depicted herein, including in flow charts and block diagrams throughout the figures, imply logical boundaries between the elements. However, according to software or hardware engineering practices, the depicted elements and the functions thereof may be implemented on computers through computer executable media having a processor capable of executing program instructions stored thereon as a monolithic software structure, as standalone software modules, or as modules that employ external routines, code, services, and so forth, or any combination of these, and all such implementations may be within the scope of the present disclosure.

Furthermore, the elements depicted in any flow chart or block diagrams or any other logical component may be implemented on a machine capable of executing program instructions. Thus, while the foregoing drawings and descriptions set forth functional aspects of the disclosed systems, no particular arrangement of software for implementing these functional aspects should be inferred from these descriptions unless explicitly stated or otherwise clear from the context. Similarly, it will be appreciated that the various steps identified and described above may be varied, and that the order of steps may be adapted to particular applications of the techniques disclosed herein. All such variations and modifications are intended to fall within the scope of this disclosure. As such, the depiction and/or description of an order for various steps should not be understood to require a particular order of execution for those steps, unless required by a particular application, or explicitly stated or otherwise clear from the context.

The methods and/or processes described above, and steps thereof, may be realized in hardware, software or any combination of hardware and software suitable for a particular application. The hardware may include a general purpose computer and/or dedicated computing device or specific computing device or particular aspect or component of a specific computing device. The processes may be realized in one or more microprocessors, microcontrollers, embedded microcontrollers, programmable digital signal processors or other programmable device, along with internal and/or external memory. The processes may also, or instead, be embodied in an application specific integrated circuit, a programmable gate array, programmable array logic, or any other device or combination of devices that may be configured to process electronic signals. It will further be appreciated that one or more of the processes may be realized as a computer executable code capable of being executed on a computer readable medium.

The Application software may be created using a structured programming language such as C, an object oriented programming language such as C++, or any other high-level or low-level programming language (including assembly languages, hardware description languages, and database programming languages and technologies) that may be stored, compiled or interpreted to run on one of the above devices, as well as heterogeneous combinations of processors, processor architectures, or combinations of different hardware and software, or any other machine capable of executing program instructions.

Thus, in one aspect, each method described above and combinations thereof may be embodied in computer executable code that, when executing on one or more computing devices, performs the steps thereof. In another aspect, the methods may be embodied in systems that perform the steps thereof, and may be distributed across devices in a number of ways, or all of the functionality may be integrated into a dedicated, standalone device or other hardware. In another aspect, the means for performing the steps associated with the processes described above may include any of the hardware and/or software described above. All such permutations and combinations are intended to fall within the scope of the present disclosure.

The invention may be embodied in program instruction set executable on one or more computers. Such instructions sets may include any one or more of the following instruction types:

Data handling and memory operations, which may include an instruction to set a register to a fixed constant value, or copy data from a memory location to a register, or vice-versa (a machine instruction is often called move, however the term is misleading), to store the contents of a register, result of a computation, or to retrieve stored data to perform a computation on it later, or to read and write data from hardware devices.

Arithmetic and logic operations, which may include an instruction to add, subtract, multiply, or divide the values of two registers, placing the result in a register, possibly setting one or more condition codes in a status register, to perform bitwise operations, e.g., taking the conjunction and disjunction of corresponding bits in a pair of registers, taking the negation of each bit in a register, or to compare two values in registers (for example, to see if one is less, or if they are equal).

Control flow operations, which may include an instruction to branch to another location in the program and execute instructions there, conditionally branch to another location if a certain condition holds, indirectly branch to another location, or call another block of code, while saving the location of the next instruction as a point to return to.

Coprocessor instructions, which may include an instruction to load/store data to and from a coprocessor, or exchanging with CPU registers, or perform coprocessor operations.

A processor of a computer of the present system may include “complex” instructions in their instruction set. A single “complex” instruction does something that may take many instructions on other computers. Such instructions are typified by instructions that take multiple steps, control multiple functional units, or otherwise appear on a larger scale than the bulk of simple instructions implemented by the given processor. Some examples of “complex” instructions include: saving many registers on the stack at once, moving large blocks of memory, complicated integer and floating-point arithmetic (sine, cosine, square root, etc.), SIMD instructions, a single instruction performing an operation on many values in parallel, performing an atomic test-and-set instruction or other read-modify-write atomic instruction, and instructions that perform ALU operations with an operand from memory rather than a register.

An instruction may be defined according to its parts. According to more traditional architectures, an instruction includes an opcode that specifies the operation to perform, such as add contents of memory to register—and zero or more operand specifiers, which may specify registers, memory locations, or literal data. The operand specifiers may have addressing modes determining their meaning or may be in fixed fields. In very long instruction word (VLIW) architectures, which include many microcode architectures, multiple simultaneous opcodes and operands are specified in a single instruction.

Some types of instruction sets do not have an opcode field (such as Transport Triggered Architectures (TTA) or the Forth virtual machine), only operand(s). Other unusual “0-operand” instruction sets lack any operand specifier fields, such as some stack machines including NOSC.

Conditional instructions often have a predicate field—several bits that encode the specific condition to cause the operation to be performed rather than not performed. For example, a conditional branch instruction will be executed, and the branch taken, if the condition is true, so that execution proceeds to a different part of the program, and not executed, and the branch not taken, if the condition is false, so that execution continues sequentially. Some instruction sets also have conditional moves, so that the move will be executed, and the data stored in the target location, if the condition is true, and not executed, and the target location not modified, if the condition is false. Similarly, IBM z/Architecture has a conditional store. A few instruction sets include a predicate field in every instruction; this is called branch predication.

The instructions constituting a program are rarely specified using their internal, numeric form (machine code); they may be specified using an assembly language or, more typically, may be generated from programming languages by compilers.

While the invention has been disclosed in connection with the preferred embodiments shown and described in detail, various modifications and improvements thereon will become readily apparent to those skilled in the art.

Accordingly, the spirit and scope of the present invention is not to be limited by the foregoing examples, but is to be understood in the broadest sense allowable by law.

The present invention will now be more fully described by reference to the following non-limiting preferred embodiments.

### PREFERRED EMBODIMENTS OF THE INVENTION

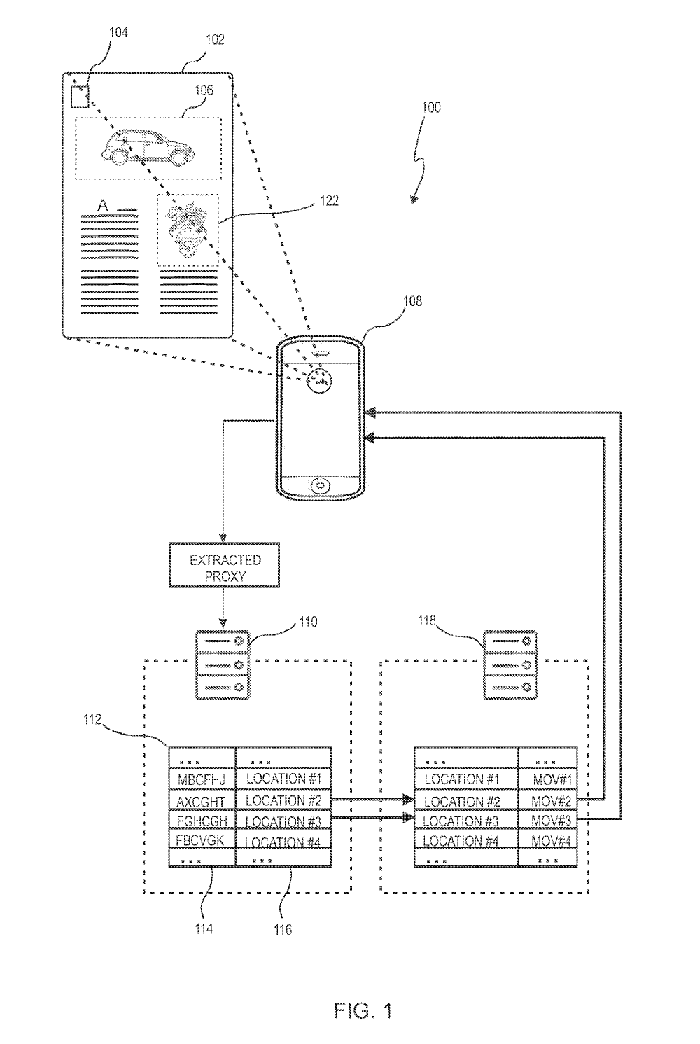

Reference is made to FIG. 1 showing a preferred embodiment of the present system 100. The system 100 comprises a hard copy image 102 which is an image in a magazine advertisement for a car. The image comprises a relatively small overlaid indicium 104 used to alert a person viewing the advertisement that the images contained therein have associated media files. The image 102 depicts a lateral view of the advertised car in the boxed area 106, the boxed area 106 comprising a substantially imperceptible watermark. The viewer capture captures the image in the box area 106 by the camera of smartphone 108. Smartphone 108 comprises application software configured to recognise the embedded watermark and decode the proxy AXCGHT which is unique to the image in the box area 106. The application software of smartphone 108 transmits the extracted proxy AXTCGHT to the server 110 which is administered by the system coordinating entity. The system coordinating entity server 110 comprises in memory a lookup table 112 having paired entries for a plurality of proxies 114 and file locations 116. The file locations correlate with files held by a third party media server 118. In this example, the proxy AXCGHT corresponds to the location LOCATION#2 of the media server 118. The system coordinating entity server 110 instructs transmission of the media file MOV#2 (since that file correlates to LOCATION#2) and the third party media server 118 streams the media file MOV#2 to viewer smartphone 108. The viewer then consumes the media file MOV#2 (in this embodiment a short movie with associated audio outlining general advantages of the vehicle) on the screen of the smartphone 108.

The viewer then views the area of the image defined by the box 122, which shows the engine of the car. The viewer is particularly interested in the engine and so trains the camera of smart phone 108 to the area defined by the box 122. The application smartphone 108 reads the substantially imperceptible watermark in the area defined by the box 122 and decodes the proxy FGHCGH which is unique to the image in the box area 122. The system coordinating entity server 110 instructs the media server 118 to stream the file MOV#3 to the smartphone 108. The viewer then consumes the media file MOV#3 (in this embodiment a short movie with associated audio outlining engine of the vehicle) on the screen of the smartphone 108.

It will be understood that the car manufacturer historically generated the media files MOV#2 and MOV#3 and uploaded same to the media file server 118.

A similar arrangement is applicable where the image is an electronic image file that is downloaded across a network. In that instance, a camera of the smartphone 108 is not used to capture an image. Instead, the image downloaded via 4G connection of WIFI connection to the Internet.

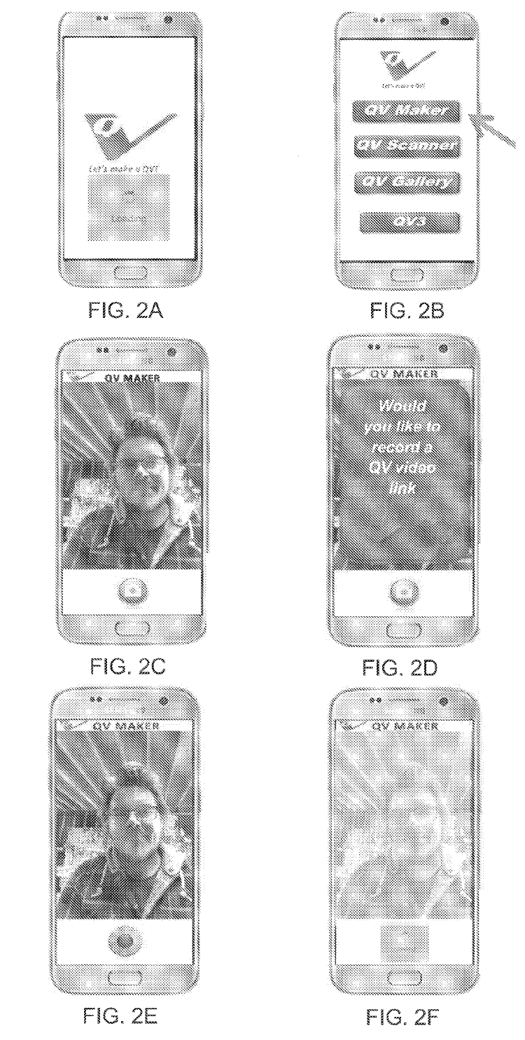

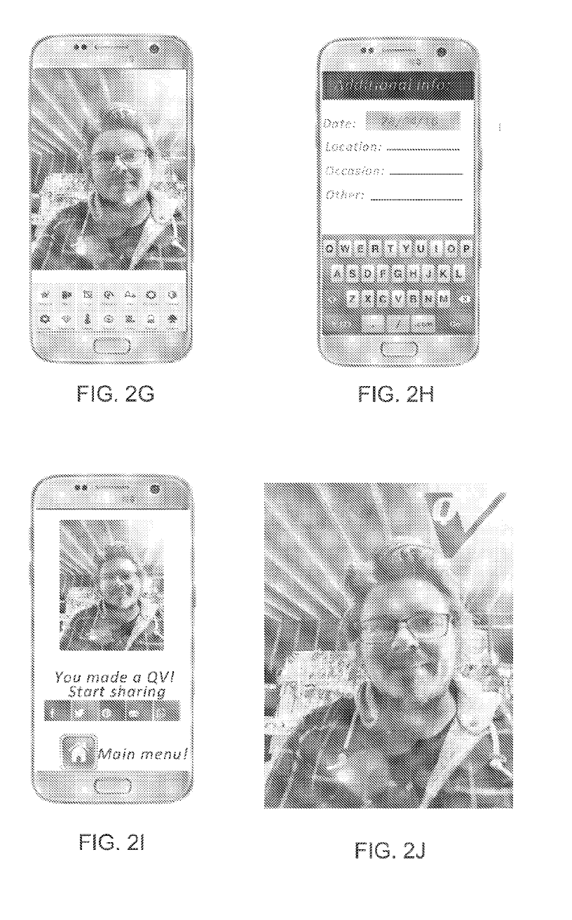

Reference is now made to FIGS. 2 to 4 show preferred embodiments of the present invention from the point of view of a smartphone user implementing the present system to generate an image, and a viewer implementing the system so as to view video content relating to the image. In these embodiments, the system is well known to the consumer under the name “QV” with associated logo. These figures show the user interface of the dedicated “QV” application resident on the smartphone. The QV application software has been previously downloaded from the Apple App Store™ or Google Play™

FIG. 2 is directed to the steps taken by a user to generate an invisibly watermarked image and associated video content.

FIG. 2A shows the user interface as the QV application is loading upon launching by a user.

Once loaded, the user is presented with a main menu (see FIG. 2B) with four main buttons being, “QV Maker”, “QV Scanner”, “QV gallery” and “QV3”. In this example, QV maker is selected, and the user is presented with a user interface similar to a prior art camera application (See FIG. 2C). The user may capture an image via either the front or back camera. Once the desired image is framed by the camera interface the camera button is actuated to capture the image. In this example, the user has used the front facing camera to capture an image of his own face.

After the image has been captured, the user is presented with a popup screen with an option to record a QV video that will be automatically associated with the image just captured (see FIG. 2D). Upon clicking the “tick” icon the application records a video message for association with the image just captured (as shown in FIG. 2E).

If the “cross” is selected instead, the user interface of FIG. 2G is presented. Once the user is pleased with the edited version he/she has the opportunity to save more information to the captured image. The application automatically records the date of the captured image and then allows the user to input location, reason for the QV (special occasion etc.) and any other text they may like to add (see FIG. 2H)

The user has an existing cloud storage account and uploads the video recorded at FIG. 2E thereto. The uploading is facilitated by an interface of the QV application (not shown). As shown in FIG. 2F the application presents a loading popup whilst applying an substantially imperceptible watermark (which is unique) to the image captured at FIG. 2C. The uniquely watermark is used to directly link to the video recorded at FIG. 2E. The application continues to upload the video to the user's cloud storage, after which time the QV application requests a share URL for the video and associates the share URL with the unique watermark for the captured image.

Once any additional information is recorded (at FIG. 2H) and the user saves the data, the data is tagged to the watermarked image. The watermarked image is then saved in the QV gallery and is ready to share or to be printed. The user is given the opportunity to share via social networking sites or messaging etc or can return to the main menu (see FIG. 2I).

If choosing to share the watermarked photo and associated video, the QV application provides a private or public option. If “private” is selected the QV application automatically connects with the user's cloud storage to change the settings of the video that was recorded and prompt the user to fill in who will be able to view. If “public” is selected the image will simply be uploaded to the desired media with a small QV indicium on the picture. The indicium will only appear when uploaded to social media pages (as shown in FIG. 2J).

If there was no video recorded the user would have the option to attach a web URL, a previously recorded video file, or a previously recorded sound file, or anything other computer-storable item. That option would be provided to the user occur between FIG. 2I and FIG. 2J.

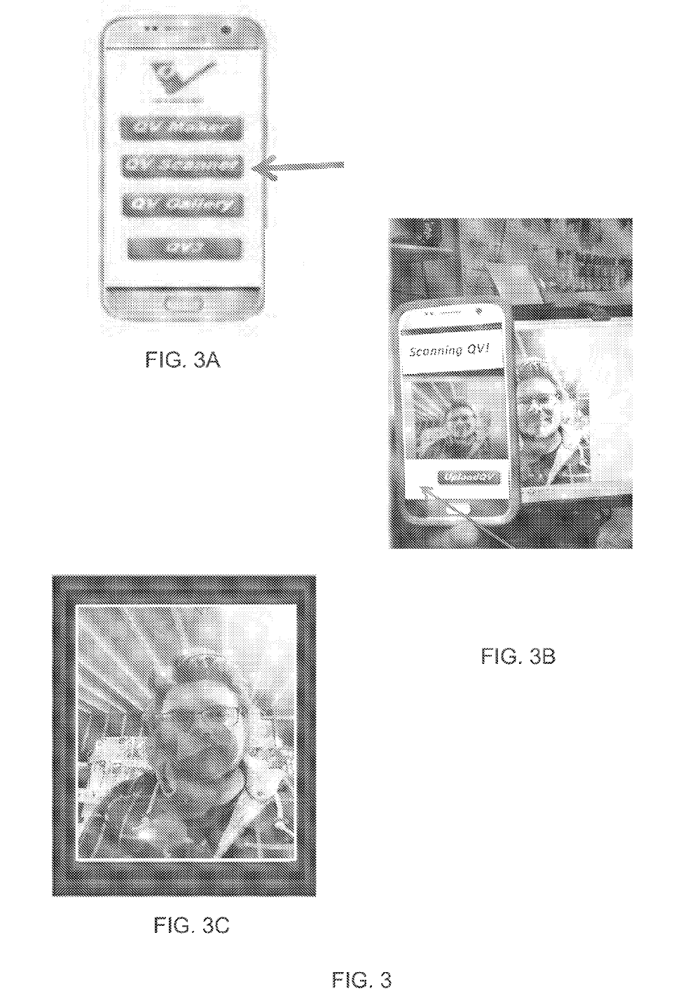

Referring now to FIG. 3 there is shown QV application user interfaces showing the selection of a scanning mode (see FIG. 3A). Where manual QV scanning is not required hence a picture message was downloaded, by clicking the upload QV button the user is able to select the image and allow the application to automatically scan and redirect to the video source (see FIG. 3B). However the QV image is shared (by e-mail, or printed picture in a frame as shown in FIG. 3C) the QV scanner finds the embedded code and automatically redirects the viewer to the shared URL to watch the video (see FIG. 3D) or download whatever file was attached.

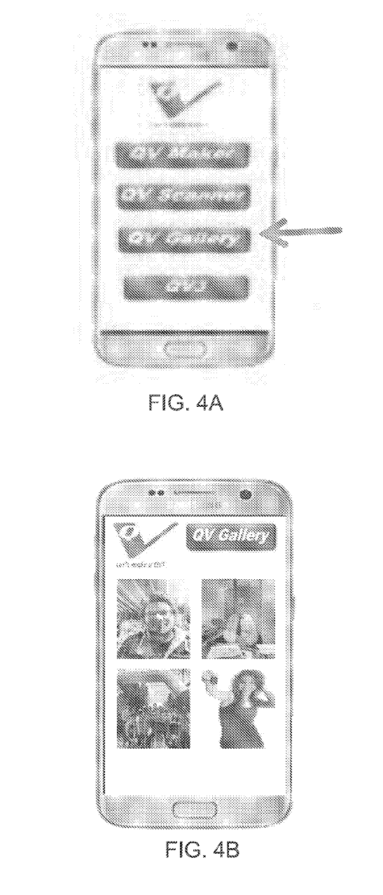

The QV application may provide a “gallery” mode as detailed in FIG. 4. The gallery mode is selected form the main menu (see FIG. 4A). The gallery mode provides the user with an opportunity to view past captured images and associated videos. The user is also able to add or delete content. For example, where a user no longer wants a recipient to be able to view s video link associated with a captured image, the video URL originally entered may be simply deleted. If the users wishes to change the video, the user may add a new URL that links to a new video.

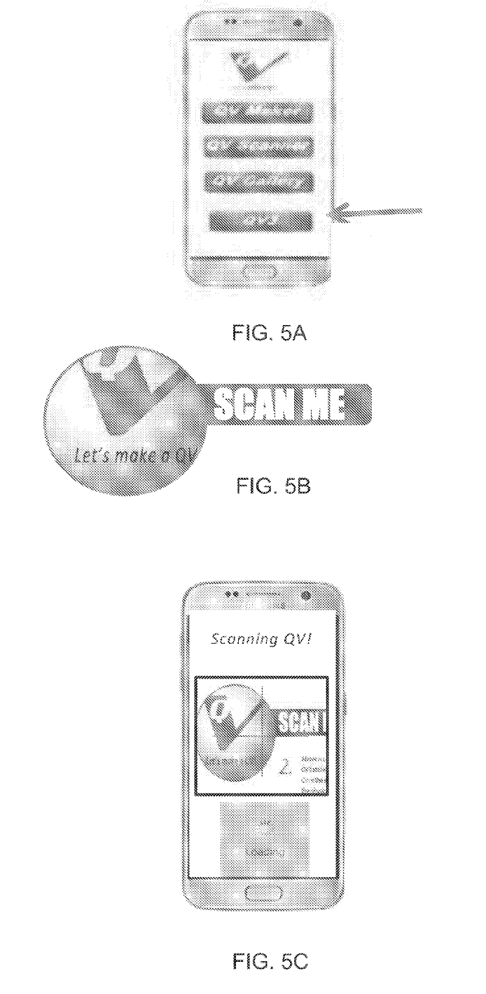

FIG. 5 shows an embodiment whereby an indicium which alerts a viewer to an associated media file is also an image onto which a watermark (and even a substantially imperceptible watermark) may be applied. Such and image/indicium may be printed as an adhesive sticker which may be applied to a greeting card. This embodiment is termed the “QV3” mode in this embodiment and is selected from the main menu as shown in FIG. 5A.

FIG. 5B shows an exemplary adhesive sticker. The watermark is substantially imperceptible and encoded mainly into the continuous tone grey region. Once the sticker is placed on a physical surface it can be scanned by the QV application (as provided under QV3 mode). Once the sticker is scanned and the application extracts the embedded code, the QV3 sticker is then used to make an associated video as per the steps commencing from FIG. 2B.

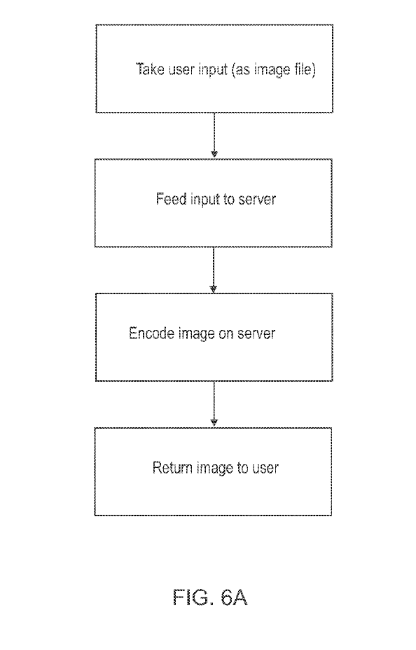

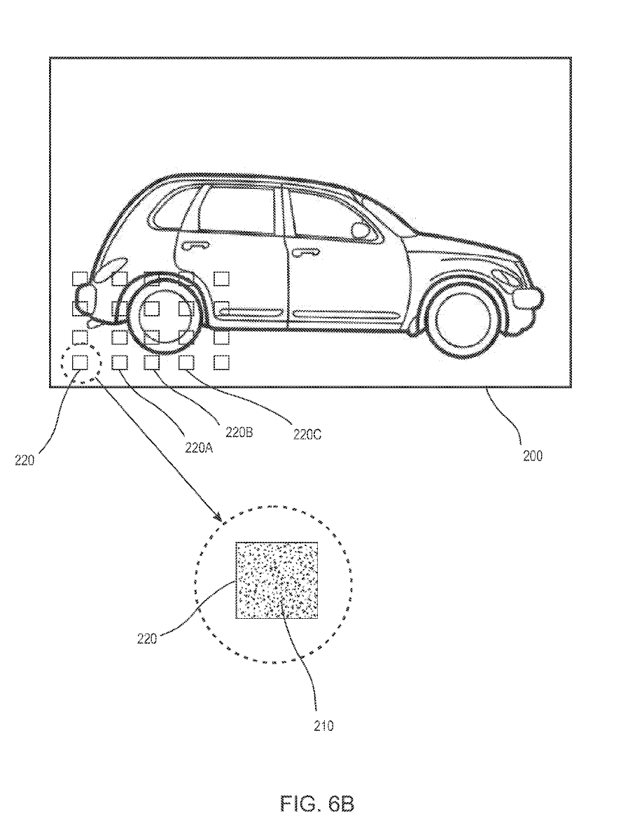

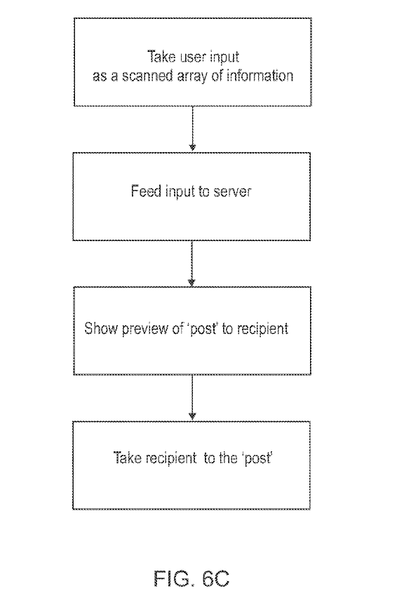

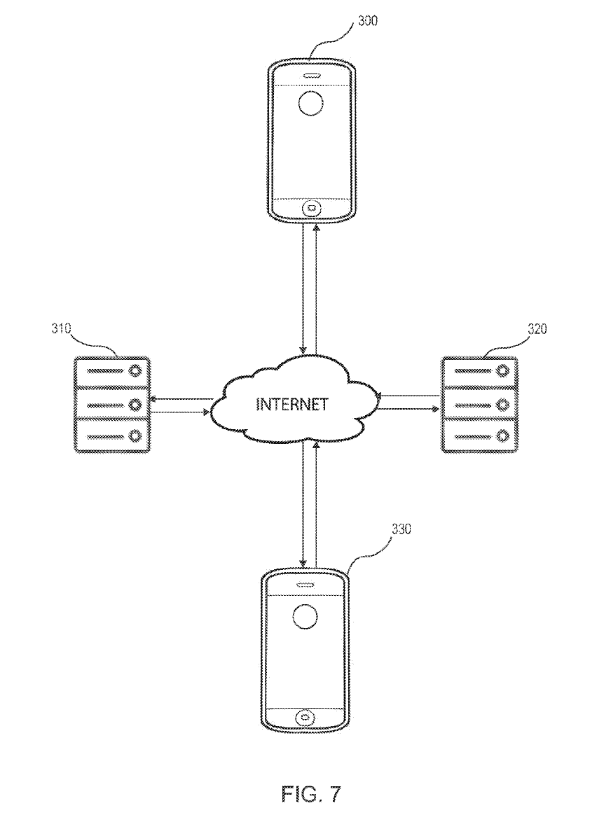

The following description relates to methods used in preferred embodiments of the invention. Reference is made to the flowcharts shown FIG. 6A, 6B and 6C detailing steps in encoding a user image, linking the user image to a media file, sending the encoded user image to the user, allowing the user to post the encoded image, scanning the image by a recipient party, and display of the associated media file to the recipient party.

Turning firstly to FIG. 6A, the flow chart commences with the step of accepting an image file (being user input). The user selects an image from either their cloud storage account (such as Dropbox™, Google Drive™, Onedrive™, etc), or from their device (smartphone) media library. The image file is selected by the user to either provide some indication of the contents of an associated media file, or to provide no indication of the contents and instead provide some comedic value or surprise in light of the associated media file.

Application software on the user device accepts the image input and uploads the image it to a dedicated server specified by the application software. Typically, the dedicated server is owned or administered by the same entity that provides the application software.

The user image is encoded with a unique user identification by encoding software of the dedicated server. The encoding software overlays a plurality of small markings onto the user image, the markings being placed so as to produce a unique identifier for that particular user image. The markings may be placed in a deliberate pattern or randomly: in either case the image is uniquely identifiable against images uploaded not only the user, but against images uploaded by all users of the present invention. The markings are disposed over a defined region of the image (such as a square region), and typically a region comprising less than 1% of the area of the image.

The encoding software then repeats the sequence in a plurality of defined regions of the image, as shown in FIG. 6B. For this Figure, it will be seen that the image 200 has overlaid a series of markings 210. The markings 210 are contained within a square region 220. The markings 210 in the square region 220 are replicated (220A, 220B, 220C . . . 220n) many times over the entire image 200. For clarity, the markings are shown only over the lower left hand corner of the image; in reality the square regions are disposed over the entire image 200.

In FIG. 6B the markings are shown in high contrast against the image that is encoded. While clearly operable, the use of contrasting markings may detract from the image overall. Preferably, the markings are configured so as to blend into the image, such that upon viewing at a reasonable distance by a person having vision within the normal range, the markings are imperceptible, or only marginally perceptible. In this way, the encoded image appears substantially the same or similar to the original image. To achieve that end, the markings may be configured in any one or more of size, shape, spacing, a color characteristic or a light characteristic.

For example, where a marking is to be placed on a red area of the image, the marking is configured so as to be perceptibly red. However, the marking will not have precisely the same color and/or light characteristics as the pixels in the original image. The slight difference in the marking compared to the background image is detectable by digital imaging means such as a digital camera of a smartphone or a scanner, but is significantly less detectable or not detectable by normal human vision. Thus, a marking will stand out against the background image when the image is captured by a smartphone camera to the extent that the image file created by the camera will have outlier pixels that are discernible against adjacent pixels. These “outlier” pixels are identifiable by algorithmic means (typically provided by application software of the analysis server) and can therefore be read by the application software as a pattern of markings across the x,y plane of the image. It is the particular pattern of markings that can be interpreted by the application software to provide a unique identifier.

The markings may be substantially imperceptible to the eye when embodied in the form of a printed image, or an image/video presented on a computer monitor, or an image/video projected onto a screen. For example, the ability of a digital camera to detect a higher resolution or light wavelengths beyond the visible spectrum may be exploited. In all cases, the markings are detectable by digital imaging means but substantially imperceptible to the human eye.

The markings may be encoded by a transformation of the image file data. For example, where the image is represented using an RGB color model, parameter(s) selected from any one or more of hue, saturation, brightness, value, and intensity may be transformed algorithmically by application software (typically on the encoding server) to determine the color and/or light characteristic of a marking. Generally, the base data for transformation is taken from the pixels of the image where the marking is to be disposed. In some embodiments, base data is taken from pixels adjacent to the proposed marking site. In other embodiments, base data is taken from pixels of the image where the marking is to be disposed and also from pixels adjacent to the proposed marking site. The data associated with the pixels may be considered individually (i.e. pixel by pixel) or may be smoothed or averaged in some manner before algorithmic transformation to provide the color and/or light characteristics of the marking.

Data associated with a color or light characteristic may be altered by greater than about 0.1, 0.2, 0.3, 0.4, 0.5, 1, 2, 3, 4, or 5%. Data associated with a color or light characteristic may be altered by less than about 0.1, 0.2, 0.3, 0.4, 0.5, 1, 2, 3, 4, or 5%.

In some embodiments, the data for the pixels in the region where a marking is to be disposed are transformed so as to be identical to a pixel within the region or a pixel adjacent to the region.

Other embodiments provide that the original image data is overlayed with marking image data, the marking image data having an associated transparency. Thus, when printed or otherwise displayed the markings on the encoded image form a semitransparent mask over the image. The overlayed data associated with each marking may uniformly alter the image in the region of each marking.

The color in the region of the marking may be additively or substantively mixed with an overlaid marking color, with a regions of mixed color forming the marking. Mixing may provide very subtle differences in color which are imperceptible to the human eye but readily detectable by digital image capture means.

In some embodiments, a marking may be uniform (so far as the associated image data is concerned), or may have variations across it so as to better blend into the image (so far as visual perception is concerned).

Disposing the markings in a repeating manner over the entire image allows for unique identifier to be read irrespective of which part of the image a camera is directed, how close/far the camera is from the image. This is distinct to a prior art barcode or QR code given that these generally require the entire asset to be visible in order to be read.

The unique identifier is associated by a database means (typically hosted on a server owned or administered by the entity which provides the device application software and the encoding server) with a media file which the user wishes to present to a recipient of the image upon capture of the encoded image. The associated media file is stored on the user's a cloud storage account. Thus, the database means comprises the unique identifier (which is encoded by the markings) in linked association with the associated media file (such as a video) held in the user's cloud storage account. The application software on the user's device (smartphone) may retains login details (e.g. user name and password) to allow for seamless selection of the associated media file by the user.

The encoding server then transmits the encoded image file for posting by the user (for example on a facebook™ wall or similar) or for printing into hardcopy form. Alternatively, the encoded image may be used as a thumbnail image or a post image.

Turning now to FIG. 6C, there is shown the steps involved in scanning the encoded image and retrieval of the media file associated with the image.

Firstly, the user input is accepted as a scanned array of information. This is achieved by the recipient of image opening the scanning function of the application software application of the user device (smartphone). As soon as the user points their device's camera at an image comprising an encoded unique identifier, the encoded identifier is recognised by the device application software and transmits the code to an association server (typically of the entity which provides the device application software and the encoding server).

The association server accepts the unique identifier as feed input used to search through a database for a record matching the unique identifier. The record is a unique post ID.

The unique post ID is transmitted to the recipient's device (smartphone) and via application software the a preview of the post is shown to the recipient. Based on human interface guidelines of Apple™ and Android™ both dictate that the user is shown a preview or more specifically a ‘confirmation of segue’ that they will be directed to a new screen and will be potentially shown third party content. Upon receipt of confirmation input by the recipient Application software of the recipient device then permits the recipient to view the post Take user to the ‘post’, which is typically a video file.

As will be appreciated by the skilled person, software for execution of the present invention may utilize open source library code to achieve many of the functions required to produce the required functions. Some functions are particular to the present invention and therefore have ben coded de novo.

This exemplary form of the invention utilizes the following open source pods (reference is made to URL: www.cocoapods.org): pod ‘AFNetworking’, pod ‘AHEasing’, pod ‘Appsee’, pod ‘Bolts’, pod ‘ChameleonFramework’, pod ‘Crashlytics’, pod ‘CTFeedback’, pod ‘CTVideoPlayerView’, pod ‘CTPersistance’, pod ‘DTPickerPresenter’, ‘˜>0.2.0’, pod ‘DVGAssetPickerController’, pod ‘DZNEmptyDataSet’, pod ‘EBPhotoPages’, pod ‘Fabric’, pod ‘FBSDKCoreKit’, pod ‘FBSDKLoginKit’, pod ‘FBSDKMessengerShareKit’, pod ‘FBSDKShareKit’, pod ‘FDFullscreenPopGesture’, pod ‘Firebase’, pod ‘FirebaseInstanceID’, pod ‘Firebase/Auth’, pod ‘Firebase/Core’, pod ‘Firebase/Database’, pod ‘Firebase/Storage’, pod ‘Google/Analytics’, pod ‘Google/SignIn’, pod ‘GoogleSignIn’, pod ‘HandyFrame’, pod ‘Harpy’, pod ‘IHKeyboardDismissing’, pod ‘INSPullToRefresh’, pod ‘IQAudioRecorderController’, pod ‘JDFPeekaboo’, pod ‘JSQMessagesViewController’, pod ‘JTSImageViewController’, pod ‘KINWebBrowser’, pod ‘KLCPopup’, pod ‘LLSimpleCamera’, ‘˜>5.0.0’, pod ‘LMDropdownView’, pod ‘Localytics’, ‘˜>4.0’, pod ‘MaterialControls’, ‘˜>1.2.2’, pod ‘MBProgressHUD’, ‘˜>1.0.0’, pod ‘MDHTMLLabel’, pod ‘MHVideoPhotoGallery’, pod ‘MZTimerLabel’, pod ‘NgKeyboardTracker’, pod ‘NSDate+TimeAgo’, pod ‘NYTPhotoViewer’, ‘˜>1.1.0’, pod ‘ObjectiveDropboxOfficial’, pod ‘OneDriveSDK’, pod ‘OneSignal’, pod ‘Parse’, pod ‘ParseCrashReporting’, pod ‘ParseFacebookUtilsV4’, pod ‘ParseUI’, pod ‘pop’, ‘˜>1.0’, pod ‘ProgressHUD’, pod ‘Reachability’, pod ‘Realm’, ‘˜>1.1.0’, pod ‘RKTagsView’, pod ‘RNCryptor’, ‘˜>3.0.1’, pod ‘RNGridMenu’, pod ‘SAMSoundEffect’, pod ‘SDWebImage’, ‘˜>3.8’, pod ‘SherginScrollableNavigationBar’, pod ‘SinchRTC’, pod ‘SinchService’, pod ‘SWTableViewCell’, pod ‘UITextView+Placeholder’, ‘—>1.2’, pod ‘VENTouchLock’, ‘˜>1.0’, pod ‘ViewUtils’

Reference is now made to FIG. 6D which shows an exemplary system of the present invention, detailing the connections and functions of the various servers and devices. The user smartphone 300 comprises application software configured to capture or select an image. The image is uploaded to the server 310 which encodes a unique identifier on the image. The encoded image is returned to the user smartphone 300. The application software of the user smartphone 300 is configured to associate a video file (not shown) with the image by way of the unique identifier encoded thereon. The association is by way of a relational database of the server 310. The video file has been previously uploaded and stored on a secure cloud storage account hosted on the server 320, the account being owned by the smartphone 300 user. The server 320 is unrelated to the server 310 in so far as ownership or administration is concerned.

The encoded image is printed in hardcopy (not shown) by whatever means. The recipient has a smartphone 330 which by its camera captures an image of the printed encoded image by way of application software. The smartphone 330 transmits the unique identifier provided by the encoding to the server 310 which by way of the relational database provides access of smartphone 330 to the video file associated with the image by allowing streaming of the video file from the server 320 to the smartphone 330.

In the description provided herein, numerous specific details are set forth. However, it is understood that embodiments of the invention may be practiced without these specific details. In other instances, well-known methods, structures and techniques have not been shown in detail in order not to obscure an understanding of this description.

In the following claims, any of the claimed embodiments can be used in any combination.

1. A system for transmitting electronic video and/or audio to a device, the system comprising:
an image comprising media file association means,
electronic storage means comprising a media file associated with the image,
a device configured to receive the image or to capture the image, the device being in operable connection with the electronic storage means,
wherein upon download or capture of the image by the device, the system utilizes the media file association means to identify the media file associated with the image and transmits the media file to the device.

2. The system of claim 1 wherein the image is embodied in the form of a physical image.

3. The system of claim 2 wherein the physical image is selected from the group consisting of a hard copy photograph or graphic, or a still or moving image presented on a television screen, a computer screen or a cinema screen.

4. The system of claim 2 wherein the device is configured to capture the physical image by digital image capture means.

5. The system of claim 1 wherein the image is embodied in the form of an electronic image file.

6. The system of claim 5 wherein the image file comprises or is associated with a computer readable identifier.

7. The system of claim 5 wherein the device is configured to receive the image by download across a network.

8. The system of claim 1 wherein the image is of photographic quality.

9. The system of claim 1 wherein the image comprises human comprehensible indicium identifying the photograph as being associated with a media file.

10. The system of claim 1 wherein the media file association means comprises the actual file location, or is a proxy for the actual file location.

11. The system of claim 1 wherein the media file association means comprises a marking, graphic, letter or numeral visible or invisible to a human, the marking graphic, letter or numeral being disposed on or about the image.

12. The system of claim 1 comprising a server owned or administered by a system coordinating entity.

13. The system of claim 12 wherein the server is configured to extract from the image or receive from the device location information, or a proxy for location information for the associated media file from the image.

14. The system of claim 13 wherein the server comprises means for linking a proxy for location information to actual location information.

15. The system of claim 12 wherein the associated media file is transmitted to the device via the server.

16. The system of claim 1 wherein the media file associated with the image is stored on a server of a secure cloud storage account of a user distributing the media file associated with the image.

17. A non-transitory computer-readable medium comprising device application software stored thereon, which when executed by a processor of a device configure the device to perform acts comprising:
receiving or capturing an image on the device,
analyzing the image the image to detect or extract a location of a media file associated with the image, or a proxy for the location of the media file associated with the image and
instigating downloading or streaming of the media file to the device.

18. An image having media file association means, wherein where the image is a physical image the media file association means is disposed on or about the image, and where the image is embodied in the form of an electronic image file the media file association means is embedded in the electronic image file.

19. The image of claim 18 wherein where the image is a physical image, the media file association means is a series of markings deliberately disposed on the physical image for the purpose of encoding media file association information.

20. The image of claim 19 wherein the markings are repeated across the image so as to provide some redundancy.

21. (canceled)

22. (canceled)

23. (canceled)

24. (canceled)
